(19) United States
(12) Patent Application Publication
(10) Pub. No.: US 2006/0184957 A1
(43) Pub. Date: Aug. 17, 2006

(54) Disk clamp mechanism with centering function

(75) Inventor: Masaki Koshino, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/347,373

(22) Filed: Feb. 6, 2006

(30) Foreign Application Priority Data
Feb. 17, 2005 (JP) 2005-040957

(51) Int. Cl. G11B 17/028; G11B 19/20; G11B 17/03

(52) U.S. Cl. 720/706

(57) ABSTRACT

The present invention enables a disk to be reliably and stably sandwiched so as to be centered with respect to a turntable while being prevented from floating. When a disk is sandwiched by placing it on a turntable, a central hole in a lower disk is guided to a positioning step portion along a lower inclined guide surface formed on a cylindrical portion. Here, even if the disk runs onto the horizontal step portion with the central hole in the lower disk failing to be fitted around the positioning step portion, a central hole in an upper disk is guided along an upper inclined guide surface to fit the central hole in the lower disk around the positioning step portion. This allows the lower disk to be centered with respect to the turntable. The disk is thus clamped between a damper and the turntable.

The present application is based on and claims priority of Japanese patent application No. 2005-040957 filed on Feb. 17, 2005, the entire contents of which are hereby incorporated by reference.

### BACKGROUND OF THE INVENTION

1. Field of the Invention

The present invention relates to a disk clamp mechanism with a centering function for fixing a disk-like recording medium such as a compact disk (CD) or a digital versatile disk (DVD) to a rotating shaft provided in a disk drive.

2. Description of the Related Art

In conventional information recording and playback devices utilizing disk-like recording media such as digital versatile disks (DVD), a turntable is secured to a rotating shaft of a spindle motor, and a disk is placed on the turntable. Then, the disk-like recording medium is sandwiched between the turntable and a clamper and rotated. Information is thus written to or read from the disk-like recording medium. Such a disk clamp mechanism comprises a centering function for concentrically positioning the disk-like recording medium with respect to a rotating shaft that drives the disk-like recording medium. For example, a disk driving device disclosed in Japanese Patent Laid-Open Publication No. 2003-346403 (Patent Document 1) is well known as a disk clamp mechanism with a centering function of this kind. In this disk driving device, as shown in FIGS. 5 and 6, a cylindrical portion C is projected from a central position of a turntable B so that a disk A can be positioned with reference to a central hole A3 formed in the disk A. The cylindrical portion C is fitted into the central hole A3 in the disk A. In this case, a guide inclined portion C1 tapered toward a tip of the cylindrical portion C is formed on a tip side of the cylindrical portion C. As the turntable B rises to the disk A from below, the guide inclined portion C1 comes into contact with the inner periphery of the central hole A3. The central hole A3 is guided along the guide inclined portion C1 and then along the outer periphery of the cylindrical portion C.

In a known structure of the disk A, for example, two disks A1 and A2 are laminated together so that recording medium surfaces are located inside. Each of the disks consists of a transparent substrate and the following four layers sequentially stacked on the transparent substrate: a dielectric film consisting of a first inorganic compound, a photomagnetic recording medium having perpendicular magnetic anisotropy, a dielectric film consisting of a second inorganic compound, and a light reflecting film that reflects light. Moreover, the entire surface of the recording medium is protectively coated with resin. In the disk A in which the two disks A1 and A2 are thus laminated together, as shown in FIG. 6, when the disks A1 and A2 are misaligned from each other owing to a molding error or the like when laminated together, the central hole A3 in the disk A has its diameter reduced. Further, a step portion a is created in a laminated part of the disks A1 and A2. The cylindrical portion C is thus likely to be caught in the step portion a. When the step portion a is caught in the cylindrical portion C, the disk A remains floating over the turntable B, thus making it difficult to sandwich the disk A between the clamper D and the turntable B. In particular, the recent trend is to rotate the disk A at high speed, so that the floating of the disk A causes the write and read direction of an optical pickup to deviate from the direction of the tracks in the rotating disk A. This may preclude information from being written to or read from the disk. In the worst case, the disk A may leave the turntable B.

### SUMMARY OF THE INVENTION

The present invention is made in view of the above problems. An object of the present invention is to provide a disk clamp mechanism with a centering function which enables a disk to be reliably placed on a turntable while being centered with respect to the turntable and which enables the disk to be stably sandwiched without floating or leaving the turntable even during rotation, the disk clamp mechanism also enabling its own thickness to be reduced.

A first aspect of the present invention provides a disk clamp mechanism with a centering function, the mechanism comprising a turntable secured to a rotating shaft of a spindle motor and a clamper supported by a support member, the turntable and the clamper sandwiching a disk-like recording medium between the turntable and the clamper, wherein a placement surface on which the disk-like recording medium is placed is formed on the turntable, and a cylindrical portion is formed which is located in a central portion of the placement surface and which passes through a central hole in the disk-like recording medium, wherein a positioning step portion is formed around a periphery of a base of the cylindrical portion so that the central hole in the disk-like recording medium is fitted around the positioning step portion to center the disk-like recording medium, and a tapered lower inclined guide surface is formed on a top surface of the positioning step portion so as to guide the disk-like recording medium to the positioning step portion, and wherein the damper is provided with a concave portion that receives the cylindrical portion and an upper inclined guide surface located around a periphery of an opening of the concave portion and abutting against an inner periphery of the central hole to guide the central hole to the positioning step portion.

With the configuration in accordance with the first aspect, the disk is conveyed to between the turntable and the clamper, and a driving unit including the spindle motor is raised. The cylindrical portion of the turntable is then inserted into the central hole in the disk. This allows the disk to be held by the cylindrical portion. Further, as the turn table rises, the central hole in the disk is guided to the positioning step portion along the lower inclined guide surface, formed around the base of the cylindrical portion. On this occasion, the central hole in the disk may run onto the positioning step portion without being fitted around the positioning step portion. However, even if the disk runs onto the positioning step portion, the central hole in the disk abuts against the tapered upper inclined guide surface, projecting from the back surface of the clamper, as the turntable rises. The disk is then guided outward along the upper inclined guide surface. This allows the central hole in the disk to be fitted around the positioning step portion, with the disk centered with respect to the turntable. With the turntable and disk centered with respect to each other, the disk is clamped by the damper and the turntable.

A second aspect of the present invention is the disk clamp mechanism with the centering function according to the first aspect, wherein the disk-like recording medium comprises an upper and lower disks that are laminated together, and with the lower disk having run onto the positioning step portion, the upper inclined guide surface is abutted against an inner periphery of the central hole in the disk-like recording medium as the turntable rises, to fit an outer peripheral surface of the positioning step portion into the central hole in the disk-like recording medium along the upper inclined guide surface.

The arrangement in accordance with the second aspect exerts the following effect. When the height of the positioning step portion including the lower inclined guide surface is minimized to reduce the thickness of the turntable, the incline of the lower inclined guide surface becomes gentler to allow the disk to run readily onto the positioning step portion. However, the disk is guided outward by the upper inclined guide surface, projecting from the back surface of the clamper. The central hole in the lower disk is thus reliably fitted around the positioning step portion. This enables the reliable centering of the lower disk, constituting a recording medium surface for the turntable.

A third aspect of the present invention is the disk clamp mechanism with the centering function according to the second aspect, wherein the height of the positioning step portion is set so that the positioning step portion is lower than the lower disk after the central hole in the lower disk has been fitted around the positioning step portion to place the disk on the placement surface of the turntable.

If the two disks are misaligned from each other when laminated together and if the positioning step portion is set lower than the lower disk, when the central hole in the lower disk is fitted around the positioning step portion, the upper disk is misaligned from the positioning step portion. However, the upper disk has a function for protecting the lower disk, constituting a recording medium surface. Consequently, even if the disk is slightly misaligned from the turntable, information can be written or read without any problem.

### BRIEF DESCRIPTION OF THE DRAWINGS

FIG. 1 is a sectional view of a disk clamp mechanism showing an embodiment of the present invention, in which a disk is about to be clamped;

FIG. 2 is an enlarged sectional view showing an essential part of FIG. 1;

FIG. 3 is a sectional view of the disk clamp mechanism showing that the disk has been clamped;

FIG. 4 is an enlarged sectional view of an essential part of FIG. 3;

FIG. 5 is a sectional view of a disk clamp mechanism in a conventional example, showing that a disk has been clamped; and

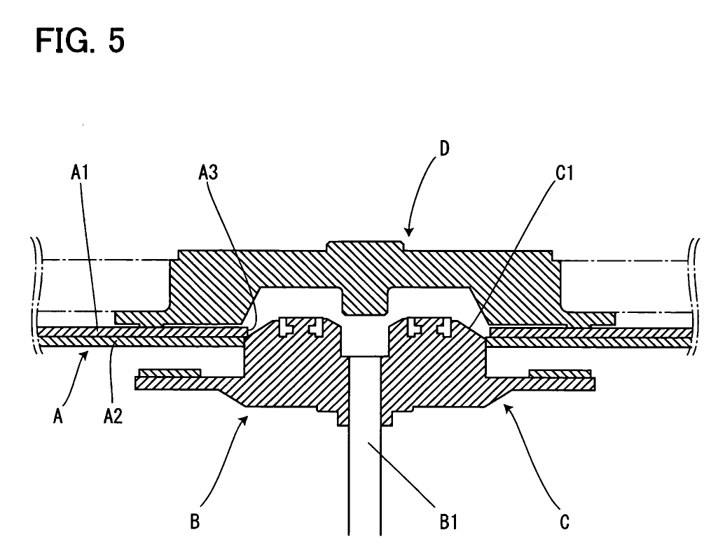

FIG. 6 is an enlarged sectional view of an essential part of FIG. 5.

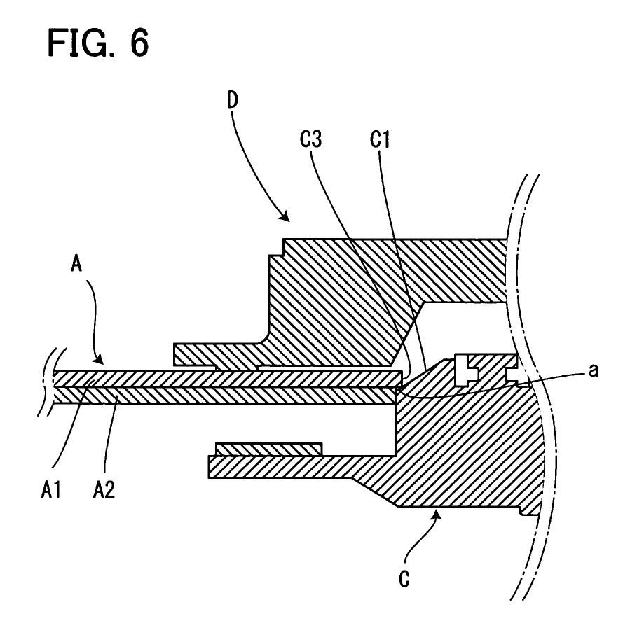

### DETAILED DESCRIPTION OF THE PREFERRED EMBODIMENT

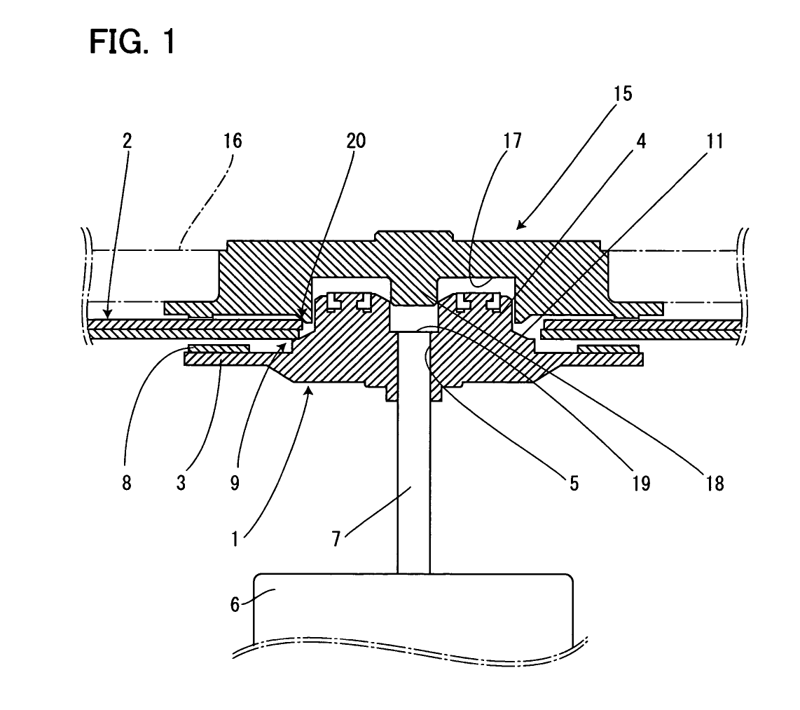

With reference to FIGS. 1 to 4, description will be given of an embodiment of the present invention, the best mode for carrying out the present invention. Of course, the present invention is easily applicable to those aspects which are not described in the embodiment, without departing from the spirit of the present invention.

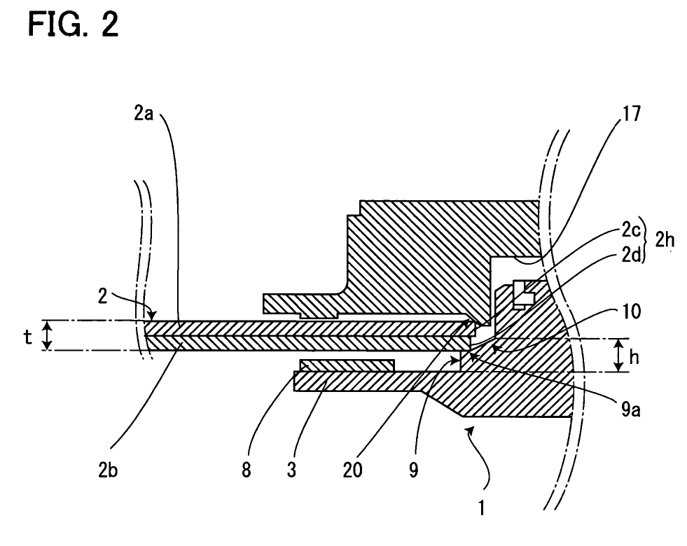

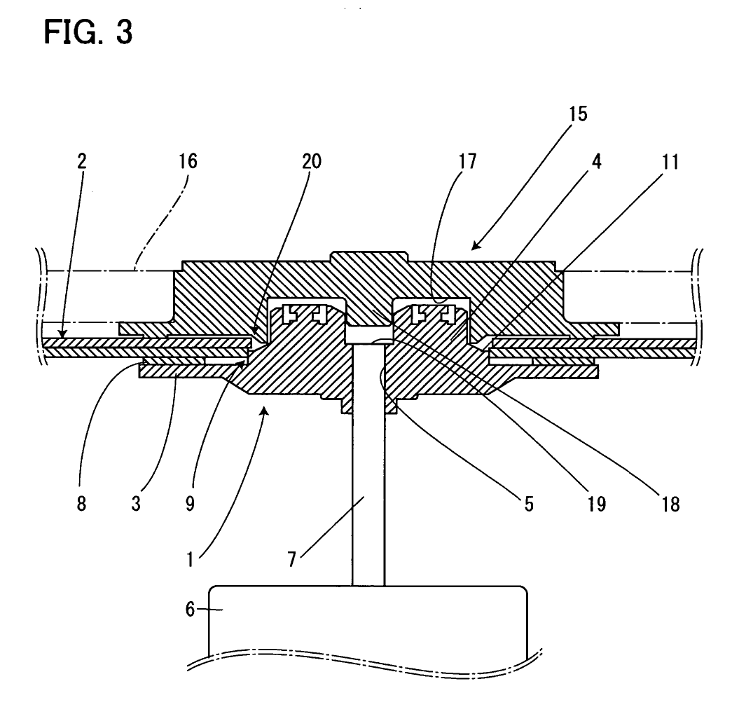

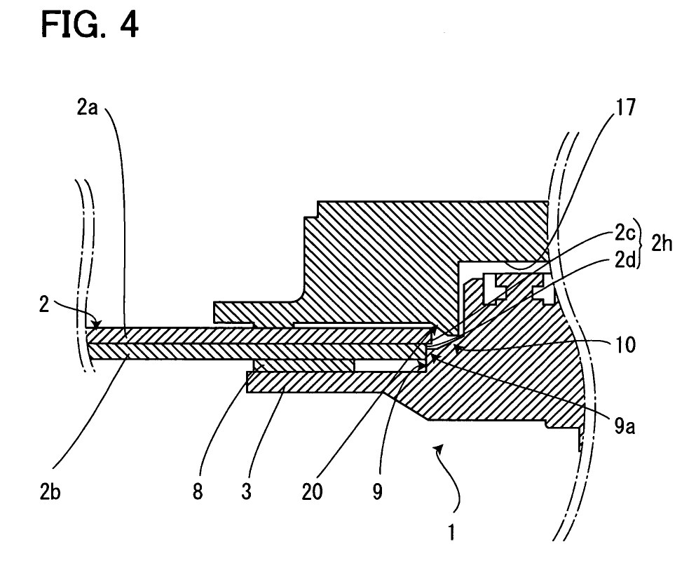

FIGS. 1 to 4 show an embodiment of the present invention. FIG. 1 is a sectional view of a disk clamp mechanism, showing a state immediately before a disk is clamped. FIG. 2 is an enlarged sectional view showing an essential part of FIG. 1. FIG. 3 is a sectional view of the disk clamp mechanism, showing that the disk has been clamped. FIG. 4 is an enlarged sectional view of an essential part of FIG. 3. In the figures, reference numeral 1 denotes a turntable formed of a synthetic resin or the like. The turntable 1 is composed of a disk-shaped placement surface 3 on which a disk 2 is placed and a cylindrical portion 4 integrally formed in a central portion of the placement surface 3. Further, a rotating shaft 7 of a spindle motor 6 is pressed into a through-hole 5 formed in the central portion of the cylindrical portion 4 to integrate the rotating shaft 7 with the turntable 1. A plurality of frictional members 8 are annularly applied to the placement surface 3 around the rotating shaft 7; the frictional members 8 consist of a rubber-like material with a large coefficient of friction. When the disk 2 is placed on the turntable 1, the frictional members 8 come into contact with the disk 2 and serve to prevent the disk 2 from slipping on the turntable 1. Further, a positioning step portion 9 is formed around the periphery of a base of the cylindrical portion 4; the positioning step portion 9 is fitted into a central hole 2h in the disk 2 so as to guide the disk 2 to a centering position when the disk 2 is placed in position. The periphery of top surface of the positioning step portion 9 constitutes a horizontal step portion 9a. Moreover, a lower inclined guide surface 10 is formed continuously with the horizontal step portion 9a so as to guide the central hole 2h in the disk 2 from the cylindrical portion 4 to the outer peripheral surface of the positioning step portion 9 toward the horizontal step portion 9a; the lower inclined guide surface 10 has a diameter increasing from the cylindrical portion 4 to the positioning step portion 9 so as to be tapered. In the present embodiment, the disk 2 is composed of two disks 2a and 2b laminated together. The positioning step portion 9 including the lower inclined guide surface 10 has a height h set lower than the thickness t of the disk 2 so that the surface of the lower disk 2b is located above the positioning step portion 9.

Reference numeral 15 denotes a clamper installed in the support member 16 opposite the turntable 1. A concave portion 17 is formed in the back surface of the damper 15 to receive the cylindrical portion 4. A positioning projection 18 is integrally formed in the center of bottom of the concave portion 17. The positioning projection 18 is fitted into a concave portion 19 formed in the center of surface of the turntable 1, to center the damper 15 and the rotating shaft 7 with respect to each other. Moreover, an upper inclined guide surface 20 is formed around the periphery of opening of the concave portion 17 so as to project from the back surface of the damper 15. The disk 2 is guided along the upper inclined guide surface 20 so that the central hole 2h in the disk 2 is guided to the positioning step portion 9.

In the present embodiment, configured as described above, the disk 2 conveyed by a tray (not shown) is first positioned between the turntable 1 and the damper 15. Driving means appropriately raises a driving unit including the spindle motor 6. The cylindrical portion 4 of the turntable 1 is thus inserted into the central hole 2h in the disk 2. This allows the disk 2 to be held by the cylindrical portion 4. Further, as the turntable 1 rises, the central hole 2d in the lower disk 2b is guided to the positioning step portion 9 along the lower inclined guide surface 10, formed around the periphery of base of the cylindrical portion 4. However, in the present embodiment, to reduce the height of the turntable 1, the height h of the positioning step portion 9 including the lower inclined guide surface 10 is set larger than the thickness t of the disk 2. This makes the incline of the lower inclined guide surface 10 gentler. Thus, although the disk 2 is guided to the positioning step portion 9 along the incline of the lower inclined guide surface 10, the disk 2 may run onto the horizontal step portion 9a with the central hole 2d in the lower disk 2b failing to be fitted around the positioning step portion 9. Even if the disk 2 runs onto the horizontal step portion 9a, the central hole 2c in the upper disk 2a abuts against the tapered upper inclined guide surface 20, projecting from the back surface of the damper 15, as the turntable 1 rises. The disk 2 is then guided outward along the upper inclined guide surface 20. This allows the central hole 2d in the lower disk 2b to be fitted around the positioning step portion 9 to center the lower disk 2b with respect to the turntable 1 and thus the rotating shaft 7. Moreover, the turntable 1 rises to insert the cylindrical portion 4 of the turntable 1 into the concave portion 17, formed in the back surface of the damper 15. The positioning projection 18, formed in the center of bottom of the concave portion 17, is fitted into the positioning concave portion 19, formed in the center of surface of the turntable 1. The disk 2 is thus sandwiched between the clamper 15 and the turntable 1 with the damper 15 and the rotating shaft 7 centered with respect to each other.

After the disk 2 is thus clamped, the turntable 1 is rotatively driven via the rotating shaft 7 of the spindle motor 6 to rotate the damper 15 and disk 2 centered with respect to each other, integrally with the turntable 1 without decentering. Further, in the present embodiment, the disk 2 is composed of the two disks 2a and 2b laminated together, with a recording medium surface formed on the lower disk 2b. The central hole 2d, formed in the lower disk 2b, forming a recording medium, is fitted around the positioning step portion 9 to center the lower disk 2b, forming a recording medium surface, with respect to the turntable 1 and thus the rotating shaft 7. Consequently, even if the disks 2a and 2b are misaligned from each other when laminated together, an optical pickup or the like (not shown) can be used to perform a realizable operation of reading information recorded on the lower disk 2b of the disk 2 being rotated or writing information to the lower disk 2b of the disk 2 being rotated.

As described above, in the present embodiment, the minimize the thickness of the damper 15, the height h of the positioning step portion 9 including the lower inclined guide surface 10 is set lower than the thickness t of the disk 2. Then, even if the inclination of the lower inclined guide surface 10 decrease to cause the disk 2 to run onto the positioning step portion 9, the central hole 2c in the upper disk 2a abuts against the tapered upper inclined guide surface 20, projecting from the back surface of the damper 15, as the turntable 1 rises. The disk 2 is then guided outward along the upper inclined guide surface 20. This allows the central hole 2d in the lower disk 2b to be reliably fitted around the positioning step portion 9 to center the lower disk 2b with respect to the turntable 1 and thus the rotating shaft 7. Thus, the height h of the positioning step portion 9 including the lower inclined guide surface 10 is set lower than the thickness t of the disk 2 so that the surface of the lower disk 2b is located above the positioning step portion 9 when the central hole 2d in the lower disk 2b is fitted around the positioning step portion 9. This enables the disk 2 to be reliably clamped by the placement surface 3 of the turntable 1 and the damper 15 even with the misalignment between the upper and lower disks 2a and 2b. Furthermore, the central hole 2d in the lower disk 2b, forming a recording medium surface, is fitted around the positioning step portion 9 to precisely center the lower disk 2b with respect to the turntable 1. Consequently, an optical pickup or the like can be used to perform a realizable operation of reading information recorded on the lower disk 2b or writing information to the lower disk 2b.

The embodiment of the present invention has been described in detail. The present invention is not limited to the above embodiment. Many variations may be made to the embodiment without departing from the spirit of the present invention. For example, in the example shown in the above embodiment, the disk is composed of the two disks 2a and 2b laminated together. However, the present invention is not limited to this. Further, the shapes of the turntable 1, damper 15, and other parts may be appropriately selected.

The disk clamp mechanism with the centering function according to the first aspect comprises the turntable secured to the rotating shaft of the spindle motor and the clamper supported by the support member. The turntable and the damper sandwiches the disk-like recording medium between the turntable and the clamper. The placement surface on which the disk-like recording medium is placed is formed on the turntable. The cylindrical portion is formed which is located in a central portion of the placement surface and which passes through the central hole in the disk-like recording medium. The positioning step portion is formed around the periphery of the base of the cylindrical portion so that the central hole in the disk-like recording medium is fitted around the positioning step portion to center the disk-like recording medium. The tapered lower inclined guide surface is formed on the top surface of the positioning step portion so as to guide the disk-like recording medium to the positioning step portion. The damper is provided with the concave portion that receives the cylindrical portion and the upper inclined guide surface located around the periphery of the opening of the concave portion and abutting against the inner periphery of the central hole to guide the central hole to the positioning step portion. Consequently, even if the central hole in the disk runs onto the positioning step portion without being fitted around the positioning step portion, it is guided along the upper inclined guide surface, projecting from the back surface of the clamper. The central hole can thus be fitted around the positioning step portion to center the disk with respect to the turntable.

The second aspect of the present invention is the disk clamp mechanism with the centering function according to the first aspect, wherein the disk-like recording medium comprises the upper and lower disks that are laminated together, and with the lower disk having run onto the positioning step portion, the upper inclined guide surface is abutted against an inner periphery of the central hole in the disk-like recording medium as the turntable rises, to fit an outer peripheral surface of the positioning step portion into the central hole in the disk-like recording medium along the upper inclined guide surface. Accordingly, when the lower inclined guide surface, along which the lower disk is guided, is set lower, the disk can be centered with respect to the turntable in spite of the reduced inclination of the lower inclined guide surface. This makes it possible to reduce the thickness of the turntable and thus of the entire device.

The third aspect of the present invention is the disk clamp mechanism with the centering function according to the second aspect, wherein the height of the positioning step portion is set so that the positioning step portion is lower than the lower disk after the central hole in the lower disk has been fitted around the positioning step portion to place the disk on the placement surface of the turntable. Accordingly, even if the two disks are misaligned from each other when laminated together, the lower disk, constituting a recording media surface, can be reliably centered with respect to the turntable. It is thus possible to perform a reliable operation of reading information recorded on the lower disk or writing information to the lower disk.

What is claimed is:

1. A disk clamp mechanism with a centering function, the mechanism comprising a turntable secured to a rotating shaft of a spindle motor and a damper supported by a support member, the turntable and the damper sandwiching a disk-like recording medium between the turntable and the clamper, wherein a placement surface on which the disk-like recording medium is placed is formed on the turntable, and a cylindrical portion is formed which is located in a central portion of the placement surface and which passes through a central hole in the disk-like recording medium, wherein a positioning step portion is formed around a periphery of a base of the cylindrical portion so that the central hole in the disk-like recording medium is fitted around the positioning step portion to center the disk-like recording medium, and a tapered lower inclined guide surface is formed on a top surface of the positioning step portion so as to guide the disk-like recording medium to the positioning step portion, and wherein the damper is provided with a concave portion that receives the cylindrical portion and an upper inclined guide surface located around a periphery of an opening of the concave portion and abutting against an inner periphery of the central hole to guide the central hole to the positioning step portion.

2. The disk clamp mechanism with the centering function according to claim 1, wherein the disk-like recording medium comprises an upper and lower disks that are laminated together, and with the lower disk having run onto the positioning step portion, the upper inclined guide surface is abutted against an inner periphery of the central hole in the disk-like recording medium as the turntable rises, to fit an outer peripheral surface of the positioning step portion into the central hole in the disk-like recording medium along the upper inclined guide surface.

3. The disk clamp mechanism with the centering function according to claim 2, wherein the height of the positioning step portion is set so that the positioning step portion is lower than the lower disk after the central hole in the lower disk has been fitted around the positioning step portion to place the disk on the placement surface of the turntable.
